(19) United States
(12) Patent Application Publication
(10) Pub. No.: US 2021/0014774 A1
(43) Pub. Date: Jan. 14, 2021

(54) Dynamically Optimizing Mobile Device Communication Modes In A Multi-Network Environment

(71) Applicant: Bank of America Corporation, Charlotte, NC (US)

(72) Inventors: Morgan S. Allen, Charlotte, NC (US); Kevin A. Delson, Woodland Hills, CA (US)

(21) Appl. No.: 16/509,762

(22) Filed: Jul. 12, 2019

(51) Int. Cl. H04W 48/16; H04W 76/14; H04W 48/18; H04L 12/24

(52) U.S. Cl. CPC H04W 48/16; H04L 41/0806; H04W 48/18; H04W 76/14

(57) ABSTRACT

Aspects of the disclosure relate to dynamically optimizing mobile device communication modes in a multi-network environment. A computing device may scan for at least one network connection associated with at least one device support server. Based on the scanning, the computing device may establish a first connection via a first network with a first device support server in a first communication mode. Subsequently, the computing device may exchange first data with the first device support server in the first communication mode. Then, the computing device may switch from the first communication mode to a second communication mode different from the first communication mode. Based on switching from the first communication mode to the second communication mode different from the first communication mode, the computing device may exchange second data with the first device support server in the second communication mode.

### BACKGROUND

Aspects of the disclosure relate to managing, controlling, and optimizing communications between different computer systems. In particular, one or more aspects of the disclosure relate to dynamically optimizing mobile device communication modes in a multi-network environment.

Wireless communications technologies continue to advance, and these advancements provide mobile computing devices with new and faster ways of communicating with each other and with remote systems and servers. In some instances, however, it may be difficult for a mobile computing device to automatically select and utilize an optimal manner of communication, particularly when also attempting to optimize resource utilization, bandwidth utilization, and efficient operations of the device itself and/or other systems and servers with which the device may be communicating.

### SUMMARY

Aspects of the disclosure provide effective, efficient, scalable, and convenient technical solutions that address and overcome the technical problems associated with managing wireless communications on mobile computing devices by dynamically optimizing mobile device communication modes in a multi-network environment.

In accordance with one or more embodiments, a computing device having at least one processor, a communication interface, and memory may scan for at least one network connection associated with at least one device support server. Based on scanning for the at least one network connection associated with the at least one device support server, the computing device may establish a first connection via a first network with a first device support server in a first communication mode. Subsequently, the computing device may exchange first data with the first device support server in the first communication mode. Then, the computing device may switch from the first communication mode to a second communication mode different from the first communication mode. Based on switching from the first communication mode to the second communication mode different from the first communication mode, the computing device may exchange second data with the first device support server in the second communication mode.

In some embodiments, scanning for the at least one network connection associated with the at least one device support server may include scanning for the at least one network connection associated with the at least one device support server based on provisioning information maintained by the computing device.

In some embodiments, the first communication mode may be associated with transmissions on a first channel and the second communication mode may be associated with transmissions on a second channel different from the first channel. In addition, exchanging the first data with the first device support server in the first communication mode may include transmitting the first data to the first device support server using the first channel. Additionally, exchanging the second data with the first device support server in the second communication mode may include transmitting the second data to the first device support server using the second channel different from the first channel.

In some embodiments, the first communication mode may be associated with transmissions on the first network and the second communication mode may be associated with transmissions on a second network different from the first network. In addition, exchanging the first data with the first device support server in the first communication mode may include transmitting the first data to the first device support server via the first network. Additionally, switching from the first communication mode to the second communication mode different from the first communication mode may include establishing a second connection via the second network with the first device support server. Further, exchanging the second data with the first device support server in the second communication mode may include transmitting the second data to the first device support server via the second network different from the first network. In some instances, the second network may be associated with a second device support server different from the first device support server.

In some embodiments, switching from the first communication mode to the second communication mode different from the first communication mode may include switching from a one-to-one communication mode to a one-to-many communication mode. In some instances, switching from the first communication mode to the second communication mode different from the first communication mode may include establishing a second connection via a second network with the first device support server. In addition, exchanging the second data with the first device support server in the second communication mode may include simultaneously transmitting first information to the first device support server via the first network and second information to the first device support server via the second network. In some instances, the first network may be a cellular network and the second network may be a non-cellular network.

In some embodiments, switching from the first communication mode to the second communication mode different from the first communication mode may include switching from the first communication mode to the second communication mode different from the first communication mode based on scheduling information defining a schedule for changing communication modes. In some instances, the scheduling information may be defined by provisioning information maintained by the computing device. In some instances, the scheduling information may be received from the first device support server when the first data is exchanged with the first device support server in the first communication mode.

In some embodiments, switching from the first communication mode to the second communication mode different from the first communication mode may include switching from the first communication mode to the second communication mode different from the first communication mode based on location information identifying a current location of the computing device.

In some embodiments, switching from the first communication mode to the second communication mode different from the first communication mode may include switching from the first communication mode to the second communication mode different from the first communication mode based on motion information identifying a movement vector of the computing device.

In some embodiments, switching from the first communication mode to the second communication mode different from the first communication mode may include switching from the first communication mode to the second communication mode different from the first communication mode based on power information identifying a current power level of the computing device.

In some embodiments, switching from the first communication mode to the second communication mode different from the first communication mode may include: scanning for at least one additional network connection associated with at least one additional device support server; applying one or more selection criteria to one or more detected network connections identified when scanning for the at least one additional network connection associated with the at least one additional device support server; and based on applying the one or more selection criteria to the one or more detected network connections, establishing a second connection different from the first connection.

In some embodiments, the computing device may receive, via the communication interface, from a second device support server different from the first device support server, a notification comprising one or more commands directing the computing device to switch communication modes. In response to receiving the notification from the second device support server different from the first device support server, the computing device may switch from the second communication mode to a third communication mode different from the first communication mode and the second communication mode. Based on switching from the second communication mode to the third communication mode, the computing device may establish a second connection via a second network with the second device support server. Subsequently, the computing device may exchange third data with the second device support server in the third communication mode.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for dynamically optimizing mobile device communication modes in a multi-network environment in accordance with one or more example embodiments;

FIGS. 2A, 2B, and 2C depict an illustrative event sequence for dynamically optimizing mobile device communication modes in a multi-network environment in accordance with one or more example embodiments;

FIGS. 3 and 4 depict example graphical user interfaces for dynamically optimizing mobile device communication modes in a multi-network environment in accordance with one or more example embodiments; and

FIG. 5 depicts an illustrative method for dynamically optimizing mobile device communication modes in a multi-network environment in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

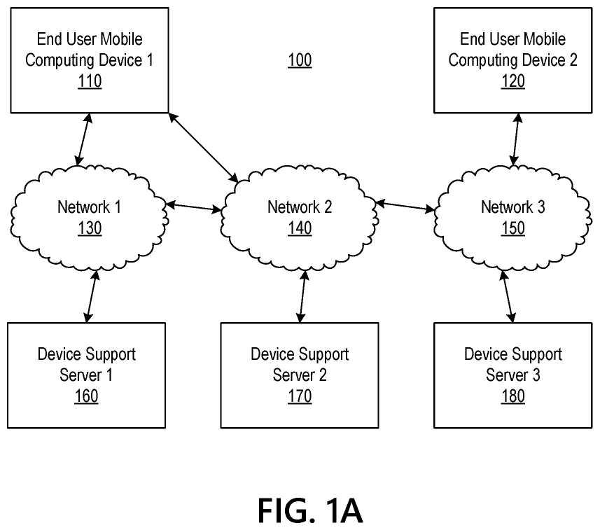

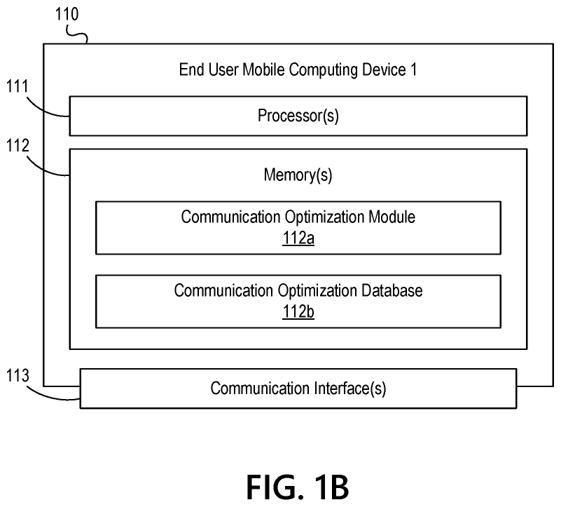

FIGS. 1A and 1B depict an illustrative computing environment for dynamically optimizing mobile device communication modes in a multi-network environment in accordance with one or more example embodiments. Referring to FIG. 1A, computing environment 100 may include one or more computer systems. For example, computing environment 100 may include a first end user mobile computing device 110, a second end user mobile computing device 120, a first device support server 160, a second device support server 170, and a third device support server 180.

As illustrated in greater detail below, end user mobile computing device 110 may be a mobile computing device that is configured to perform one or more of the functions described herein. For example, end user mobile computing device 110 may include one or more computer components (e.g., processors, memories, communication interfaces, and so on) and may be linked to and/or used by a first user (who may, e.g., be a customer or an employee of an enterprise organization operating device support server 160, device support server 170, and/or device support server 180). Similarly, end user mobile computing device 120 may be a mobile computing device that is additionally or alternatively configured to perform one or more of the functions described herein. For example, end user mobile computing device 120 may include one or more computer components (e.g., processors, memories, communication interfaces, and so on) and may be linked to and/or used by a second user (who may, e.g., be a customer or an employee of an enterprise organization operating device support server 160, device support server 170, and/or device support server 180, different from the first user of end user mobile computing device 110).

Device support server 160 may include one or more computing devices and/or other computer components (e.g., processors, memories, communication interfaces). In addition, and as illustrated in greater detail below, device support server 160 may be configured to host and/or otherwise provide one or more networks (which may, e.g., include broadcasting and/or otherwise hosting one or more wireless networks) that may be used to facilitate communications between various devices, servers, and/or other systems included in computing environment 100. For instance, device support server 160 may be configured to host and/or otherwise provide network 130, as illustrated in greater detail below.

Device support server 170 also may include one or more computing devices and/or other computer components (e.g., processors, memories, communication interfaces). In addition, and as illustrated in greater detail below, device support server 170 may be configured to host and/or otherwise provide one or more networks (which may, e.g., include broadcasting and/or otherwise hosting one or more wireless networks) that may be used to facilitate communications between various devices, servers, and/or other systems included in computing environment 100. For instance, device support server 170 may be configured to host and/or otherwise provide network 140, as illustrated in greater detail below.

Device support server 180 also may include one or more computing devices and/or other computer components (e.g., processors, memories, communication interfaces). In addition, and as illustrated in greater detail below, device support server 180 may be configured to host and/or otherwise provide one or more networks (which may, e.g., include broadcasting and/or otherwise hosting one or more wireless networks) that may be used to facilitate communications between various devices, servers, and/or other systems included in computing environment 100. For instance, device support server 180 may be configured to host and/or otherwise provide network 150, as illustrated in greater detail below.

As introduced above, computing environment 100 also may include one or more networks, which may interconnect one or more of end user mobile computing device 110, end user mobile computing device 120, device support server 160, device support server 170, and device support server 180. For example, computing environment 100 may include a first network 130 (which may, e.g., be hosted and/or otherwise provided by device support server 160), a second network 140 (which may, e.g., be hosted and/or otherwise provided by device support server 170), and a third network 150 (which may, e.g., be hosted and/or otherwise provided by device support server 180). Any and/or all of network 130, network 140, and network 150 may include one or more private networks, public networks, sub-networks, and/or the like.

In one or more arrangements, end user mobile computing device 110, end user mobile computing device 120, device support server 160, device support server 170, device support server 180, and/or the other systems included in computing environment 100 may be any type of computing device capable of receiving a user interface, receiving input via the user interface, and communicating the received input to one or more other computing devices. For example, end user mobile computing device 110, end user mobile computing device 120, device support server 160, device support server 170, device support server 180, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of end user mobile computing device 110, end user mobile computing device 120, device support server 160, device support server 170, and device support server 180 may, in some instances, be special-purpose computing devices configured to perform specific functions.

Referring to FIG. 1B, end user mobile computing device 110 may include one or more processors 111, memory 112, and communication interface 113. A data bus may interconnect processor 111, memory 112, and communication interface 113. Communication interface 113 may be a network interface configured to support communication between end user mobile computing device 110 and one or more networks (e.g., network 130, network 140, network 150, or the like). Memory 112 may include one or more program modules having instructions that when executed by processor 111 cause end user mobile computing device 110 to perform one or more functions described herein and/or one or more databases that may store and/or otherwise maintain information which may be used by such program modules and/or processor 111. For example, memory 112 may have, store, and/or include a communication optimization module 112a and a communication optimization database 112b. Communication optimization module 112a may have instructions that direct and/or cause end user mobile computing device 110 to dynamically optimize mobile device communication modes in a multi-network environment, as discussed in greater detail below. Communication optimization database 112b may store information used by communication optimization module 112a and/or end user mobile computing device 110 in dynamically optimizing mobile device communication modes in a multi-network environment.

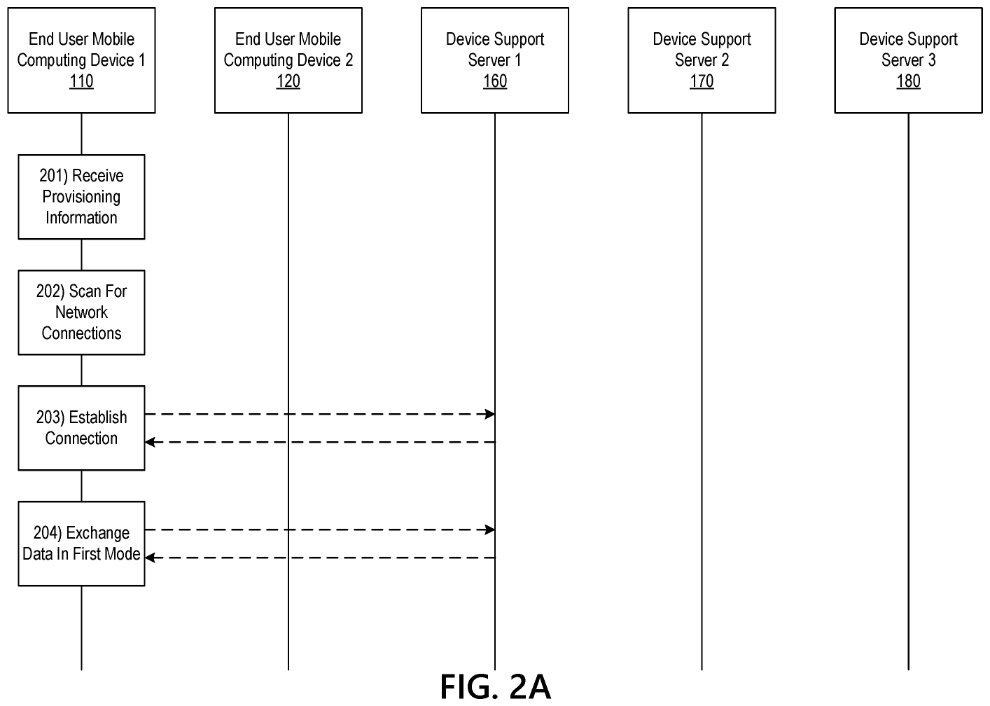

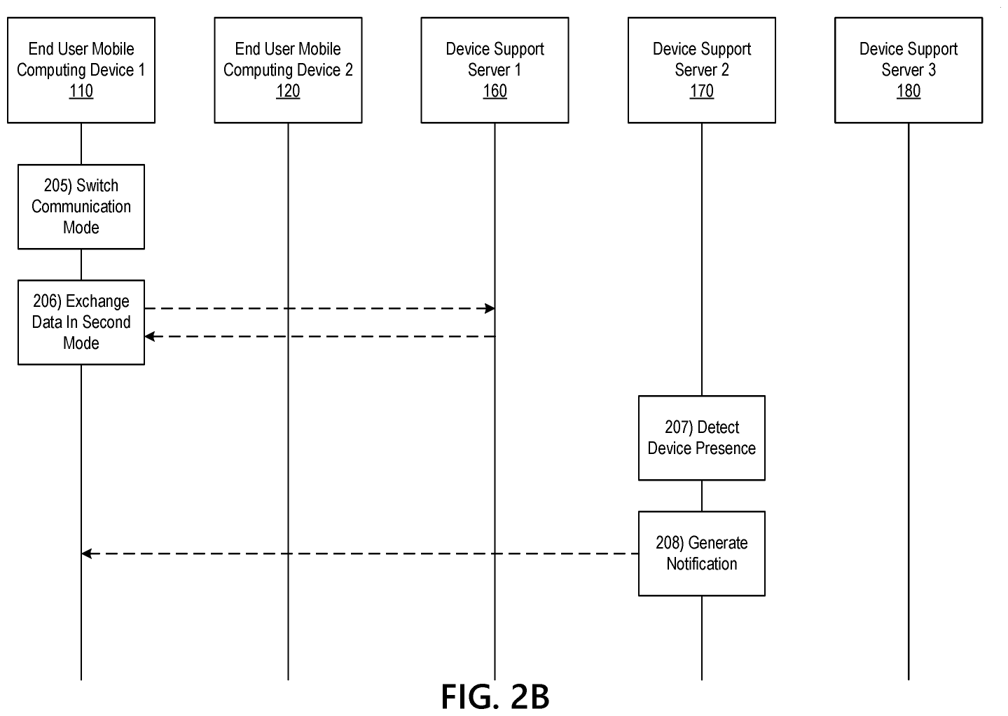

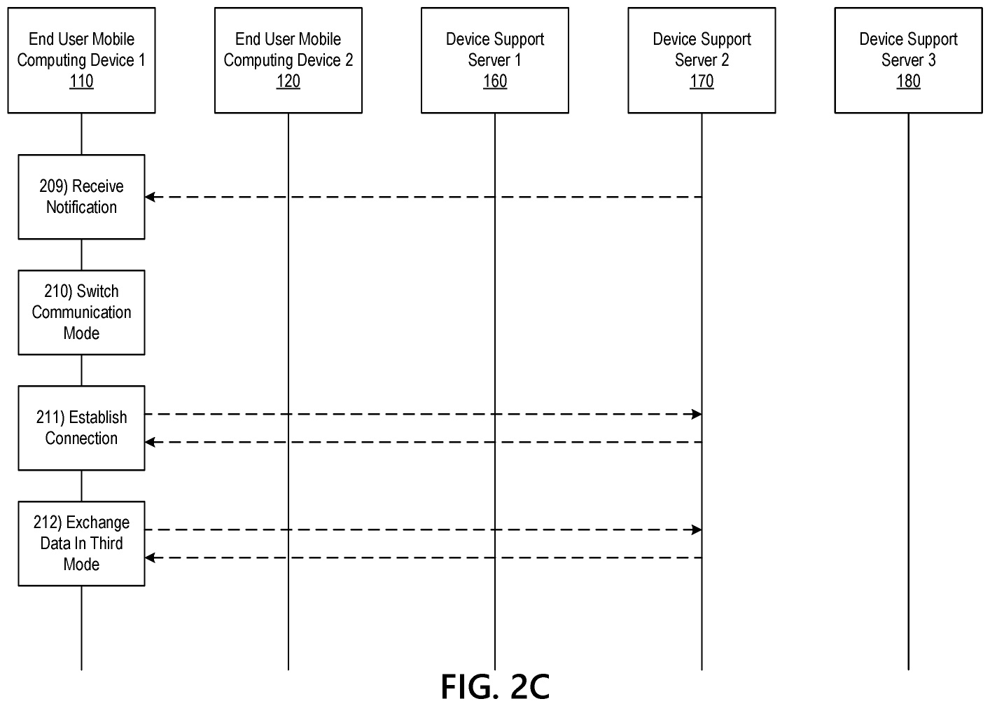

FIGS. 2A, 2B, and 2C depict an illustrative event sequence for dynamically optimizing mobile device communication modes in a multi-network environment in accordance with one or more example embodiments. Referring to FIG. 2A, at step 201, end user mobile computing device 110 may receive provisioning information. For example, at step 201, end user mobile computing device 110 may receive provisioning information from one or more users, one or more servers, and/or one or more media sources, and such provisioning information may be associated with one or more of device support server 160, device support server 170, and/or device support server 180. For instance, the provisioning information received by end user mobile computing device 110 may include networks addresses, broadcast frequencies, transmission channels, and/or other information associated with one or more networks that are hosted and/or otherwise provided by device support server 160, device support server 170, and/or device support server 180.

At step 202, end user mobile computing device 110 may scan for one or more network connections. For example, at step 202, end user mobile computing device 110 may scan for at least one network connection associated with at least one device support server (e.g., device support server 160, device support server 170, device support server 180). In some embodiments, scanning for the at least one network connection associated with the at least one device support server may include scanning for the at least one network connection associated with the at least one device support server based on provisioning information maintained by the computing device. For example, in scanning for the at least one network connection associated with the at least one device support server (e.g., device support server 160, device support server 170, device support server 180) at step 202, end user mobile computing device 110 may scan for the at least one network connection associated with the at least one device support server (e.g., device support server 160, device support server 170, device support server 180) based on provisioning information maintained by the computing device (e.g., end user mobile computing device 110), such as the provisioning information received by end user mobile computing device 110 at step 201.

At step 203, end user mobile computing device 110 may establish a connection with device support server 160. For example, at step 203, based on scanning for the at least one network connection associated with the at least one device support server, end user mobile computing device 110 may establish a first connection via a first network (e.g., network 130) with a first device support server (e.g., device support server 160) in a first communication mode. As discussed in greater detail below, the first communication mode may define that communications involving end user mobile computing device 110 occur via a specific network, on a specific channel, or the like.

At step 204, end user mobile computing device 110 may exchange data in the first communication mode. For example, at step 204, end user mobile computing device 110 may exchange first data with the first device support server (e.g., device support server 160) in the first communication mode.

Referring to FIG. 2B, at step 205, end user mobile computing device 110 may switch communication modes. For example, at step 205, end user mobile computing device 110 may switch from the first communication mode to a second communication mode different from the first communication mode. In some instances, end user mobile computing device 110 may seamlessly transition from the first communication mode to the second communication mode, such that data may be constantly exchanged by end user mobile computing device 110 despite the occurrence of the switching event. In some instances, to seamlessly transition between the communication modes in this manner, end user mobile computing device 110 may temporarily operate in both communication modes for a relatively short amount of time (e.g., one second, five seconds, or the like). In addition, during this overlap period, end user mobile computing device 110 may communicate with device support server 160 in both modes (e.g., both the first communication mode and the second communication mode).

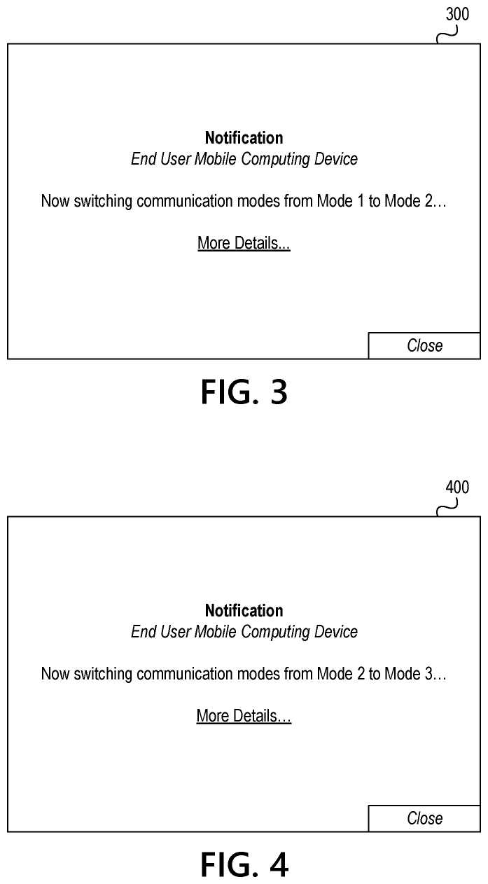

In some instances, in switching from the first communication mode to the second communication mode, end user mobile computing device 110 may display and/or otherwise present a graphical user interface similar to graphical user interface 300, which is illustrated in FIG. 3. As seen in FIG. 3, graphical user interface 300 may include text and/or other content indicating that end user mobile computing device 110 is switching communication modes (e.g., “Now switching communication modes from Mode 1 to Mode 2 . . . |More Details . . . ”).

At step 206, end user mobile computing device 110 may exchange data in the second communication mode. For example, at step 206, based on switching from the first communication mode to the second communication mode different from the first communication mode, end user mobile computing device 110 may exchange second data with the first device support server (e.g., device support server 160) in the second communication mode.

In some embodiments, the first communication mode may be associated with transmissions on a first channel and the second communication mode may be associated with transmissions on a second channel different from the first channel. In addition, exchanging the first data with the first device support server in the first communication mode may include transmitting the first data to the first device support server using the first channel. Additionally, exchanging the second data with the first device support server in the second communication mode may include transmitting the second data to the first device support server using the second channel different from the first channel. For example, the first communication mode may be associated with transmissions on a first wireless network channel (which may, e.g., correspond to a first radio frequency range) and the second communication mode may be associated with transmissions on a second wireless network channel (which may, e.g., correspond to a second radio frequency range different from the first radio frequency range). In addition, in exchanging the first data with the first device support server (e.g., device support server 160) in the first communication mode at step 204, end user mobile computing device 110 may transmit the first data to the first device support server (e.g., device support server 160) using the first channel. Additionally, in exchanging the second data with the first device support server (e.g., device support server 160) in the second communication mode at step 206, end user mobile computing device 110 may transmit the second data to the first device support server (e.g., device support server 160) using the second channel different from the first channel. In some instances, both the first channel and the second channel may be associated with fifth-generation (5G) wireless networks, such that end user mobile computing device 110 is dynamically and seamlessly switching between channels on a 5G wireless network that is hosted and/or otherwise provided by device support server 160.

In some embodiments, the first communication mode may be associated with transmissions on the first network and the second communication mode may be associated with transmissions on a second network different from the first network. In addition, exchanging the first data with the first device support server in the first communication mode may include transmitting the first data to the first device support server via the first network. Additionally, switching from the first communication mode to the second communication mode different from the first communication mode may include establishing a second connection via the second network with the first device support server. Further, exchanging the second data with the first device support server in the second communication mode may include transmitting the second data to the first device support server via the second network different from the first network. For example, the first communication mode may be associated with transmissions on the first network (e.g., network 130) and the second communication mode may be associated with transmissions on a second network (e.g., network 140). In addition, in exchanging the first data with the first device support server (e.g., device support server 160) in the first communication mode at step 204, end user mobile computing device 110 may transmit the first data to the first device support server (e.g., device support server 160) via the first network (e.g., network 130). Additionally, in switching from the first communication mode to the second communication mode different from the first communication mode at step 205, end user mobile computing device 110 may establish a second connection via the second network (e.g., network 140) with the first device support server (e.g., device support server 160). Further, in exchanging the second data with the first device support server (e.g., device support server 160) in the second communication mode at step 206, end user mobile computing device 110 may transmit the second data to the first device support server (e.g., device support server 160) via the second network (e.g., network 140).

In some embodiments, the second network may be associated with a second device support server different from the first device support server. For example, the second network (e.g., network 140) may be associated with a second device support server (e.g., device support server 170) different from the first device support server (e.g., device support server 160). For instance, the second network (e.g., network 140) may be hosted and/or otherwise provided by the second device support server (e.g., device support server 170).

In some embodiments, switching from the first communication mode to the second communication mode different from the first communication mode may include switching from a one-to-one communication mode to a one-to-many communication mode. For example, in switching from the first communication mode to the second communication mode different from the first communication mode at step 205, end user mobile computing device 110 may switch from a one-to-one communication mode to a one-to-many communication mode.

In some embodiments in which end user mobile computing device 110 switches from a one-to-one communication mode to a one-to-many communication mode, switching from the first communication mode to the second communication mode different from the first communication mode may include establishing a second connection via a second network with the first device support server. In addition, exchanging the second data with the first device support server in the second communication mode may include simultaneously transmitting first information to the first device support server via the first network and second information to the first device support server via the second network. For example, in switching from the first communication mode to the second communication mode different from the first communication mode at step 205, end user mobile computing device 110 may establish a second connection via a second network (e.g., network 140) with the first device support server (e.g., device support server 160). In addition, in exchanging the second data with the first device support server (e.g., device support server 160) in the second communication mode at step 206, end user mobile computing device 110 may simultaneously transmit first information to the first device support server (e.g., device support server 160) via the first network (e.g., network 130) and second information to the first device support server (e.g., device support server 160) via the second network (e.g., network 140).

In some embodiments in which end user mobile computing device 110 switches from a one-to-one communication mode to a one-to-many communication mode, the first network may be a cellular network and the second network may be a non-cellular network. For example, the first network may, in some instances, be a cellular network, such as a 5G wireless network, and the second network may be a non-cellular network, such as a wireless local area network (WLAN).

In some embodiments, switching from the first communication mode to the second communication mode different from the first communication mode may include switching from the first communication mode to the second communication mode different from the first communication mode based on scheduling information defining a schedule for changing communication modes. For example, in switching from the first communication mode to the second communication mode different from the first communication mode at step 205, end user mobile computing device 110 may switch from the first communication mode to the second communication mode different from the first communication mode based on scheduling information defining a schedule for changing communication modes.

In some embodiments, the scheduling information may be defined by provisioning information maintained by the computing device. For example, the scheduling information (which may, e.g., dictate when end user mobile computing device 110 should switch communication modes) may be defined by provisioning information maintained by the computing device (e.g., end user mobile computing device 110). Such scheduling information may be received and/or created during provisioning (e.g., at step 201) or when a connection is initially established (e.g., at step 203).

In some embodiments, the scheduling information may be received from the first device support server when the first data is exchanged with the first device support server in the first communication mode. For example, the scheduling information may be received (e.g., by end user mobile computing device 110) from the first device support server (e.g., device support server 160) when the first data is exchanged with the first device support server (e.g., device support server 160) in the first communication mode (e.g., at step 204). In some instances, such scheduling information may define a server-generated schedule and/or a random schedule for switching between channels, networks, and/or other aspects of communication modes. For instance, device support server 160 may send information to end user mobile computing device 110 (or vice versa) indicating that a channel switch should occur in a predetermined amount of time (e.g., “switch from channel X to channel Y in 5 seconds). Then, both device support server 160 and end user mobile computing device 110 may, for instance, synchronize their timers and switch channels when such timers expire, seamlessly and without data loss.

In some embodiments, switching from the first communication mode to the second communication mode different from the first communication mode may include switching from the first communication mode to the second communication mode different from the first communication mode based on location information identifying a current location of the computing device. For example, in switching from the first communication mode to the second communication mode different from the first communication mode at step 205, end user mobile computing device 110 may switch from the first communication mode to the second communication mode different from the first communication mode based on location information identifying a current location of the computing device (e.g., end user mobile computing device 110). For instance, end user mobile computing device 110 may switch communication modes as its location changes (e.g., and as different network connections become stronger or weaker, more or less stable, or the like).

In some embodiments, switching from the first communication mode to the second communication mode different from the first communication mode may include switching from the first communication mode to the second communication mode different from the first communication mode based on motion information identifying a movement vector of the computing device. For example, in switching from the first communication mode to the second communication mode different from the first communication mode at step 205, end user mobile computing device 110 may switch from the first communication mode to the second communication mode different from the first communication mode based on motion information identifying a movement vector of the computing device (e.g., end user mobile computing device 110). For instance, end user mobile computing device 110 may switch communication modes based on a movement vector indicating that end user mobile computing device 110 is moving towards or away from particular networks, towers, or the like.

In some embodiments, switching from the first communication mode to the second communication mode different from the first communication mode may include switching from the first communication mode to the second communication mode different from the first communication mode based on power information identifying a current power level of the computing device. For example, in switching from the first communication mode to the second communication mode different from the first communication mode at step 205, end user mobile computing device 110 may switch from the first communication mode to the second communication mode different from the first communication mode based on power information identifying a current power level of the computing device (e.g., end user mobile computing device 110). For instance, end user mobile computing device 110 may switch communication modes based on its power level increasing (which may, e.g., cause end user mobile computing device 110 to switch to a weaker, but faster, network) or its power level decreasing (which may e.g., cause end user mobile computing device 110 to switch to a stronger, but slower, network).

In some embodiments, switching from the first communication mode to the second communication mode different from the first communication mode may include: scanning for at least one additional network connection associated with at least one additional device support server; applying one or more selection criteria to one or more detected network connections identified when scanning for the at least one additional network connection associated with the at least one additional device support server; and based on applying the one or more selection criteria to the one or more detected network connections, establishing a second connection different from the first connection. For example, in switching from the first communication mode to the second communication mode different from the first communication mode at step 205, end user mobile computing device 110 may scan for at least one additional network connection associated with at least one additional device support server (e.g., different from the first network connection associated with device support server 160). In addition, end user mobile computing device 110 may apply one or more selection criteria to one or more detected network connections identified when scanning for the at least one additional network connection associated with the at least one additional device support server (e.g., device support server 170, device support server 180). Then, based on applying the one or more selection criteria to the one or more detected network connections, end user mobile computing device 110 may establish a second connection different from the first connection. For instance, end user mobile computing device 110 may scan for new connections and apply such selection criteria to detected connections to select one or more connections to establish.

At step 207, device support server 170 may detect a presence and/or movement of end user mobile computing device 110. For example, at step 207, device support server 170 may detect that end user mobile computing device 110 is moving towards and/or has entered a range of one or more networks being hosted by and/or otherwise provided by device support server 170. At step 208, device support server 170 may generate and/or send a notification to end user mobile computing device 110 (e.g., based on detecting the presence and/or movement of end user mobile computing device 110).

Referring to FIG. 2C, at step 209, end user mobile computing device 110 may receive the notification from device support server 170. For example, at step 209, end user mobile computing device 110 may receive, via the communication interface (e.g., communication interface 113), from a second device support server (e.g., device support server 170) different from the first device support server (e.g., device support server 160), a notification comprising one or more commands directing the computing device (e.g., end user mobile computing device 110) to switch communication modes. For instance, and as illustrated above, device support server 170 may detect that end user mobile computing device 110 is moving towards it and/or its networks, and may send such a notification with such commands that trigger end user mobile computing device 110 to switch communication modes (e.g., to a network and/or mode associated with device support server 170).

At step 210, end user mobile computing device 110 may switch communication modes. For example, at step 210, in response to receiving the notification from the second device support server (e.g., device support server 170) different from the first device support server (e.g., device support server 160), end user mobile computing device 110 may switch from the second communication mode to a third communication mode different from the first communication mode and the second communication mode. In some instances, end user mobile computing device 110 may seamlessly transition from the second communication mode to the third communication mode, such that data may be constantly exchanged by end user mobile computing device 110 despite the occurrence of the switching event. In some instances, to seamlessly transition between the communication modes in this manner, end user mobile computing device 110 may temporarily operate in both communication modes for a relatively short amount of time (e.g., one second, five seconds, or the like). In addition, during this overlap period, end user mobile computing device 110 may communicate with device support server 160 and/or device support server 170 in both modes (e.g., both the second communication mode and the third communication mode).

In some instances, in switching from the second communication mode to the third communication mode, end user mobile computing device 110 may display and/or otherwise present a graphical user interface similar to graphical user interface 400, which is illustrated in FIG. 4. As seen in FIG. 4, graphical user interface 400 may include text and/or other content indicating that end user mobile computing device 110 is switching communication modes (e.g., “Now switching communication modes from Mode 2 to Mode 3 . . . |More Details . . . ”).

At step 211, end user mobile computing device 110 may establish a connection with device support server 170. For example, at step 211, based on switching from the second communication mode to the third communication mode, end user mobile computing device 110 may establish a second connection via a second network (e.g., network 140) with the second device support server (e.g., device support server 170).

At step 212, end user mobile computing device 110 may exchange data in the third communication mode. For example, at step 212, end user mobile computing device 110 may exchange third data with the second device support server (e.g., device support server 170) in the third communication mode.

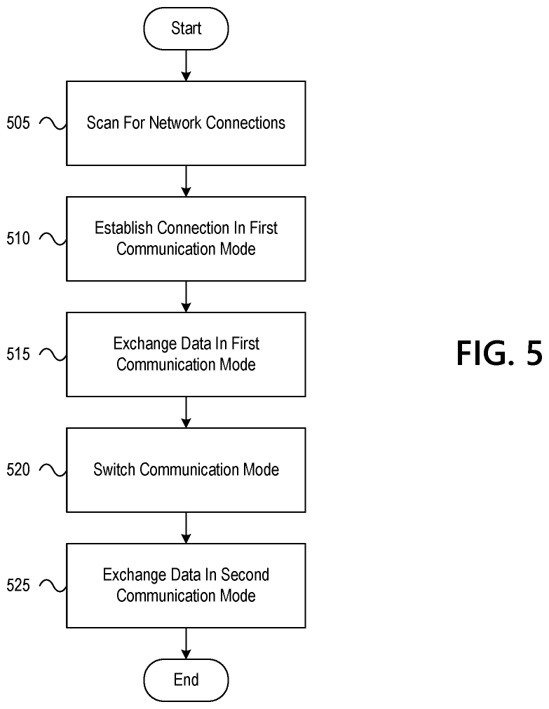

FIG. 5 depicts an illustrative method for dynamically optimizing mobile device communication modes in a multi-network environment in accordance with one or more example embodiments. Referring to FIG. 5, at step 505, a computing device having at least one processor, a communication interface, and memory may scan for at least one network connection associated with at least one device support server. At step 510, based on scanning for the at least one network connection associated with the at least one device support server, the computing device may establish a first connection via a first network with a first device support server in a first communication mode. At step 515, the computing device may exchange first data with the first device support server in the first communication mode. At step 520, the computing device may switch from the first communication mode to a second communication mode different from the first communication mode. At step 525, based on switching from the first communication mode to the second communication mode different from the first communication mode, the computing device may exchange second data with the first device support server in the second communication mode.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing device, comprising:
at least one processor;
a communication interface communicatively coupled to the at least one processor; and
memory storing computer-readable instructions that, when executed by the at least one processor, cause the computing device to:
scan for at least one network connection associated with at least one device support server;
based on scanning for the at least one network connection associated with the at least one device support server, establish a first connection via a first network with a first device support server in a first communication mode;
exchange first data with the first device support server in the first communication mode;
switch from the first communication mode to a second communication mode different from the first communication mode; and
based on switching from the first communication mode to the second communication mode different from the first communication mode, exchange second data with the first device support server in the second communication mode.

2. The computing device of claim 1, wherein scanning for the at least one network connection associated with the at least one device support server comprises scanning for the at least one network connection associated with the at least one device support server based on provisioning information maintained by the computing device.

3. The computing device of claim 1,
wherein the first communication mode is associated with transmissions on a first channel and the second communication mode is associated with transmissions on a second channel different from the first channel,
wherein exchanging the first data with the first device support server in the first communication mode comprises transmitting the first data to the first device support server using the first channel, and
wherein exchanging the second data with the first device support server in the second communication mode comprises transmitting the second data to the first device support server using the second channel different from the first channel.

4. The computing device of claim 1,
wherein the first communication mode is associated with transmissions on the first network and the second communication mode is associated with transmissions on a second network different from the first network,
wherein exchanging the first data with the first device support server in the first communication mode comprises transmitting the first data to the first device support server via the first network,
wherein switching from the first communication mode to the second communication mode different from the first communication mode comprises establishing a second connection via the second network with the first device support server, and
wherein exchanging the second data with the first device support server in the second communication mode comprises transmitting the second data to the first device support server via the second network different from the first network.

5. The computing device of claim 4, wherein the second network is associated with a second device support server different from the first device support server.

6. The computing device of claim 1, wherein switching from the first communication mode to the second communication mode different from the first communication mode comprises switching from a one-to-one communication mode to a one-to-many communication mode.

7. The computing device of claim 6,
wherein switching from the first communication mode to the second communication mode different from the first communication mode comprises establishing a second connection via a second network with the first device support server, and
wherein exchanging the second data with the first device support server in the second communication mode comprises simultaneously transmitting first information to the first device support server via the first network and second information to the first device support server via the second network.

8. The computing device of claim 7, wherein the first network is a cellular network and the second network is a non-cellular network.

9. The computing device of claim 1, wherein switching from the first communication mode to the second communication mode different from the first communication mode comprises switching from the first communication mode to the second communication mode different from the first communication mode based on scheduling information defining a schedule for changing communication modes.

10. The computing device of claim 9, wherein the scheduling information is defined by provisioning information maintained by the computing device.

11. The computing device of claim 9, wherein the scheduling information is received from the first device support server when the first data is exchanged with the first device support server in the first communication mode.

12. The computing device of claim 1, wherein switching from the first communication mode to the second communication mode different from the first communication mode comprises switching from the first communication mode to the second communication mode different from the first communication mode based on location information identifying a current location of the computing device.

13. The computing device of claim 1, wherein switching from the first communication mode to the second communication mode different from the first communication mode comprises switching from the first communication mode to the second communication mode different from the first communication mode based on motion information identifying a movement vector of the computing device.

14. The computing device of claim 1, wherein switching from the first communication mode to the second communication mode different from the first communication mode comprises switching from the first communication mode to the second communication mode different from the first communication mode based on power information identifying a current power level of the computing device.

15. The computing device of claim 1, wherein switching from the first communication mode to the second communication mode different from the first communication mode comprises:
scanning for at least one additional network connection associated with at least one additional device support server;
applying one or more selection criteria to one or more detected network connections identified when scanning for the at least one additional network connection associated with the at least one additional device support server; and
based on applying the one or more selection criteria to the one or more detected network connections, establishing a second connection different from the first connection.

16. The computing device of claim 1, wherein the memory stores additional computer-readable instructions that, when executed by the at least one processor, cause the computing device to:
receive, via the communication interface, from a second device support server different from the first device support server, a notification comprising one or more commands directing the computing device to switch communication modes;
in response to receiving the notification from the second device support server different from the first device support server, switch from the second communication mode to a third communication mode different from the first communication mode and the second communication mode;
based on switching from the second communication mode to the third communication mode, establish a second connection via a second network with the second device support server; and
exchange third data with the second device support server in the third communication mode.

17. A method, comprising:
at a computing device comprising at least one processor, a communication interface, and memory:
scanning, by the at least one processor, for at least one network connection associated with at least one device support server;
based on scanning for the at least one network connection associated with the at least one device support server, establishing, by the at least one processor, a first connection via a first network with a first device support server in a first communication mode;
exchanging, by the at least one processor, first data with the first device support server in the first communication mode;
switching, by the at least one processor, from the first communication mode to a second communication mode different from the first communication mode; and
based on switching from the first communication mode to the second communication mode different from the first communication mode, exchanging, by the at least one processor, second data with the first device support server in the second communication mode.

18. The method of claim 17, wherein scanning for the at least one network connection associated with the at least one device support server comprises scanning for the at least one network connection associated with the at least one device support server based on provisioning information maintained by the computing device.

19. The method of claim 17,
wherein the first communication mode is associated with transmissions on a first channel and the second communication mode is associated with transmissions on a second channel different from the first channel,
wherein exchanging the first data with the first device support server in the first communication mode comprises transmitting the first data to the first device support server using the first channel, and
wherein exchanging the second data with the first device support server in the second communication mode comprises transmitting the second data to the first device support server using the second channel different from the first channel.

20. One or more non-transitory computer-readable media storing instructions that, when executed by a computing device comprising at least one processor, a communication interface, and memory, cause the computing device to:
scan for at least one network connection associated with at least one device support server;
based on scanning for the at least one network connection associated with the at least one device support server, establish a first connection via a first network with a first device support server in a first communication mode;
exchange first data with the first device support server in the first communication mode;
switch from the first communication mode to a second communication mode different from the first communication mode; and
based on switching from the first communication mode to the second communication mode different from the first communication mode, exchange second data with the first device support server in the second communication mode.
